(19) United States
(12) Patent Application Publication
(10) Pub. No.: US 2018/0258783 A1
(43) Pub. Date: Sep. 13, 2018

(54) ABRADABLE MATERIAL COATING REPAIR AND STEAM TURBINE STATIONARY COMPONENT

(71) Applicant: General Electric Company, Schenectady, NY (US)

(72) Inventors: David Charles Kirchhoff, Porter Corners, NY (US); Donald Thomas Blais, Clifton Park, NY (US)

(21) Appl. No.: 15/452,879

(22) Filed: Mar. 8, 2017

(51) Int. Cl. F01D 11/12; F01D 25/00; F01D 5/12; C23C 4/02; C23C 4/01; C23C 4/12; C23C 4/10; B24C 1/00; B24C 11/00

(52) U.S. Cl. CPC F01D 11/122; F01D 25/005; F01D 5/12; F01D 25/002; C23C 4/02; C23C 4/01; F05D 2230/90; C23C 4/10; B24C 1/00; B24C 11/00; F05D 2220/31; F05D 2230/10; C23C 4/12

(57) ABSTRACT

A method according to disclosure may include removing only a portion of a used abradable material layer on a metal sealing surface of a first component that interacts with an abradable sealing element extending from a second component. The first and second component may be, in one example, vanes and rotor of a steam turbine, that sealingly move relative to one another in an operative state. The method includes thermal spray layer a new abradable material layer on the used abradable material layer, rather than completely removing the used abradable material and starting over on bare metal.

### BACKGROUND OF THE INVENTION

The disclosure relates generally to repair of machine components, and more particularly, to repair of an abradable material coating, for example, on a steam turbine stationary component.

Various machines incorporate abradable material coatings to, for example, protect component surfaces and create other structures. For example, steam turbines use abradable material coatings to create steam seals between stages of the turbine. More particularly, steam turbines include a rotor and a plurality of axially spaced rotor wheels extending from the rotor. A plurality of rotating blades are mechanically coupled to each rotor wheel and arranged in rows that extend circumferentially around each rotor wheel. A stationary component that extends around the plurality of rotating blades includes a plurality of stationary vanes that extend circumferentially around the rotor, and axially between adjacent rows of blades. The stationary vanes extend from a carrier, outer ring or diaphragm that forms the stationary steam path. The stationary vanes cooperate with the rotating blades to form a stage and to define a portion of a steam flow path through the steam turbine.

Steam turbines use inter-stage seals to prevent steam from passing about stationary vanes and/or rotating blades. In particular, airfoils of the rotating blades that include blade covers may be provided with integral teeth machined into the covers that interact with metal sealing surfaces of the stationary component to create a seal. Further, in locations between rotor wheels on the rotor, the rotor may also be provided with teeth to seal with internally facing metal sealing surfaces on the stationary vanes to create a seal. Abradable material coatings are applied to metal sealing surfaces of the stationary component (e.g., internally facing surfaces on the vanes and/or sealing surfaces of the diaphragm adjacent to the rotating sealing teeth) to minimize clearance and damage when contact occurs between these components during operation. The abradable material coatings and teeth are initially configured to interfere such that they wear to an optimal setting when first used. For example, the tip(s) of the teeth wear against the abradable material coating, preventing damage to the teeth and the metal sealing surface. Over time, the wear on the abradable material coating creates a gap between the teeth and sealing surface that allows steam leakage therethrough, and such leakage may degrade performance. The wear may be non-uniform on the abrasive material coating such that the abradable material coating may be completely removed in some locations exposing the underlying metal sealing surface.

The current approach to repair the stationary components is to remove the part from the steam turbine, completely remove the abradable material coating (e.g., with sand blasting) to the underlying metal sealing surface, and then reform the initial abradable material coating. The reforming process may include repeating the initial abradable material layer process by plasma spraying a bond layer on the bare metal followed by plasma spraying an abradable material layer on the bond layer. The new abradable material layer is only formed on the bond layer (never over a previous abradable material layer), and is formed to the same thickness as the initial abradable material layer, which may not close the gap with the worn teeth once the component is reinstalled. This process is also time consuming and expensive because the abradable material must be completely removed after the components are removed from the steam turbine, and consequently the components oftentimes must be sent to another location for the work.

### BRIEF DESCRIPTION OF THE INVENTION

A first aspect of the disclosure provides a method, including: removing only a portion of a used abradable material coating on a metal sealing surface of a first component that interacts with an abradable sealing element extending from a second component, the first and second component sealingly moving relative to one another in an operative state; and thermal spray coating a new abradable material layer on the used abradable material layer, after the removing.

A second aspect of the disclosure provides a steam turbine (ST) stationary component, including: a metal sealing surface including an abradable material coating thereon, the abradable material coating including: a bond layer on the metal sealing surface, an oxidized abradable material layer over the bond layer, the oxidized abradable layer having a non-uniform thickness; and a non-oxidized abradable material layer over the oxidized abradable material layer, the non-oxidized abradable material layer creating a substantially uniform thickness abradable material layer with the oxidized abradable material layer.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIG. 1 shows a perspective partial cut-away illustration of a conventional steam turbine.

FIG. 2 shows a cross-sectional view of a steam turbine (ST) stationary component in situ in a steam turbine.

FIG. 3 shows a perspective view of a stationary component apart from a steam turbine including a used abradable material coating.

FIG. 4 shows an enlarged, cross-sectional view of a stationary component including an abradable material coating according to embodiments of the disclosure.

FIG. 5 shows an enlarged, cross-sectional view of a stationary component including a process of removing a portion of a used abradable material coating according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION OF THE INVENTION

As an initial matter, in order to clearly describe the current disclosure it will become necessary to select certain terminology when referring to and describing relevant machine components within an illustrative machine in the form of a steam turbine. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

In addition, several descriptive terms may be used regularly herein, and it should prove helpful to define these terms at the onset of this section. These terms and their definitions, unless stated otherwise, are as follows. It is often required to describe parts that are at differing radial positions with regard to a center axis. The term “radial” refers to movement or position perpendicular to an axis. In cases such as this, if a first component resides closer to the axis than a second component, it will be stated herein that the first component is “radially inward” or “inboard” of the second component. If, on the other hand, the first component resides further from the axis than the second component, it may be stated herein that the first component is “radially outward” or “outboard” of the second component. The term “axial” refers to movement or position parallel to an axis. It will be appreciated that such terms may be applied in relation to the center axis of the machine.

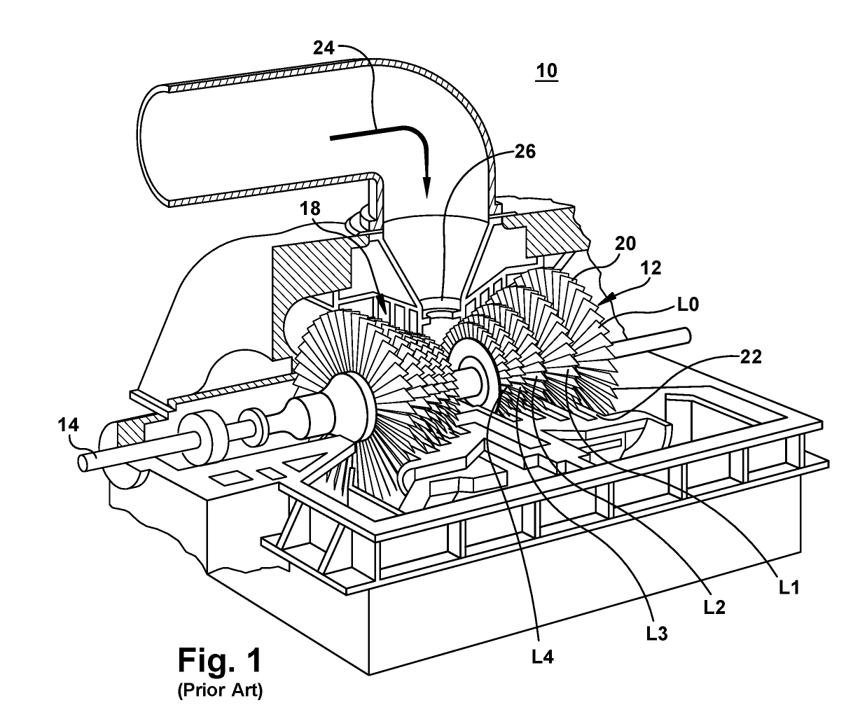

Referring to the drawings, FIG. 1 shows a perspective partial cut-away illustration of an illustrative machine in which teachings of the disclosure can be employed. For purposes of description, the illustrative machine includes a steam turbine 10. As will be apparent to those with skill in the art, the teachings of the disclosure may be applicable to a wide variety of machines. Steam turbine 10 includes a rotor 12 that includes a rotating shaft 14 and a plurality of axially spaced rotor wheels 18. A plurality of rotating blades 20 are mechanically coupled to each rotor wheel 18. More specifically, blades 20 are arranged in rows that extend circumferentially around each rotor wheel 18. A plurality of stationary vanes 22 extends circumferentially around shaft 14, and the vanes are axially positioned between adjacent rows of blades 20. Stationary vanes 22 cooperate with blades 20 to form a stage and to define a portion of a steam flow path through turbine 10.

In operation, steam 24 enters an inlet 26 of turbine 10 and is channeled through stationary vanes 22. Vanes 22 direct steam 24 downstream against blades 20. Steam 24 passes through the remaining stages imparting a force on blades 20 causing shaft 14 to rotate. At least one end of turbine 10 may extend axially away from rotor 12 and may be attached to a load or machinery (not shown) such as, but not limited to, a generator, and/or another turbine.

In one example, as shown in FIG. 1, steam turbine 10 comprises five stages. The five stages are referred to as L0, L1, L2, L3 and L4. Stage L4 is the first stage and is the smallest (in a radial direction) of the five stages. Stage L3 is the second stage and is the next stage in an axial direction. Stage L2 is the third stage and is shown in the middle of the five stages. Stage L1 is the fourth and next-to-last stage. Stage L0 is the last stage and is the largest (in a radial direction). It is to be understood that five stages are shown as one example only, and each turbine may have more or less than five stages.

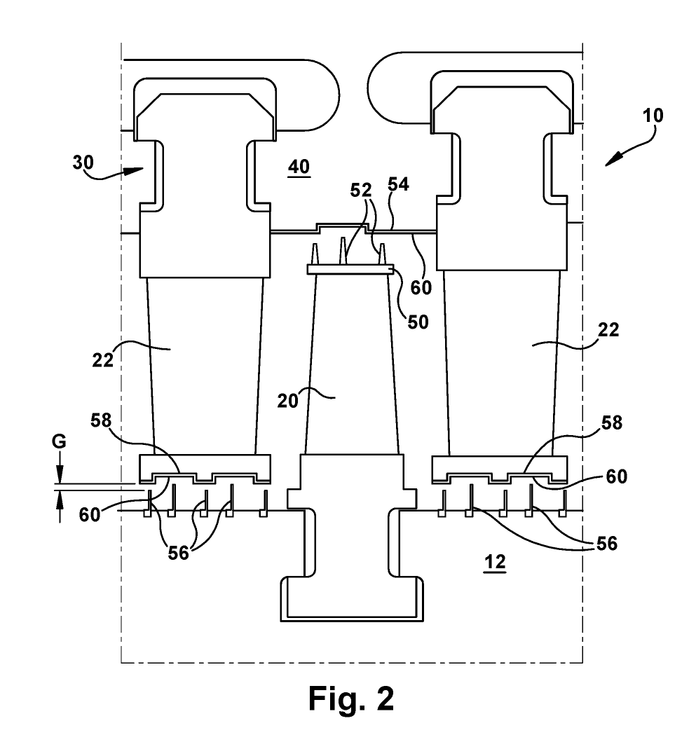

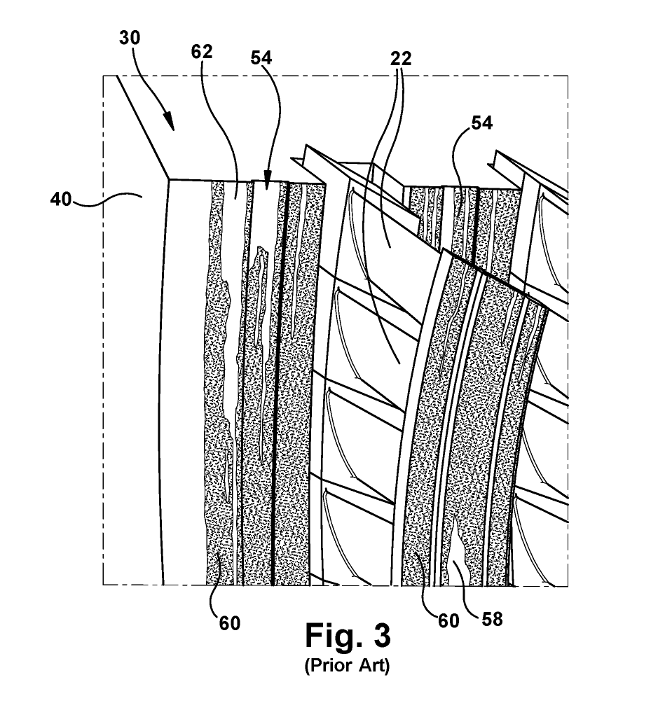

FIG. 2 shows a cross-sectional view of a steam turbine (ST) stationary component 30 in situ in steam turbine 10, and FIG. 3 shows a perspective view of stationary component 30 apart from the steam turbine. As illustrated in FIG. 2, rotating blade(s) 20 extend radially from rotor 12 (second component) between pair(s) of stationary vanes 22 (first component). Stationary vanes 22 are mounted to a casing 40. Stationary vanes 22 and casing 40 constitute ST stationary component 30 of steam turbine 10. ST stationary component 30 may be made of any metal now known or later developed for use in steam turbine 10, e.g., a metal or metal alloy. As understood, each part of stationary component 30 may include various cooling channels (not shown) therein to permit use in the hot environment of steam turbine 10.

A cover 50 of rotating blade 20 may include a plurality of abradable seal elements 52 (commonly referred to as seal teeth) extending radially outwardly therefrom that abrade against an abradable material coating 60 on a metal seal surface 54 of casing 40. Similarly, a plurality of abradable seal elements 56 (seal teeth) may extend radially outwardly from rotor 12 to abrade against an abradable material coating 60 on a metal seal surface 58 of stationary vanes 22. As understood in the art, vanes 22 and/or casing 40 (first component) and abradable seal elements 52, 56 (second components) sealingly move relative to one another in an operative state of steam turbine to prevent leakage of steam thereabout. More particularly, abradable seal elements 52, 56 are abraded by abradable material coating 60 as rotor 12 rotates during operation. The close interaction of abradable seal elements 52, 56 and abradable material coating 60 creates a steam seal at each element. Abradable material coating 60 may have an initial thickness of, for example, no greater than approximately 1 millimeter (mm). As illustrated, each metal seal surface 54, 58 may be optionally stepped to assist in preventing passage of steam therethrough.

Abradable material coating 60 is shown in FIG. 3 on stationary component 30 in a used state, i.e., it is a used abradable material coating 60. In this state, used abradable material coating 60 may include wear areas 62 therein or therethrough from interaction with abradable seal elements 52, 56 (FIG. 2) that thin abradable material coating 60, increasing a gap G (FIG. 2) between itself and elements 52, 56 and/or expose metal seal surfaces 54, 58. Used abradable material coating 60 may include a conventional bond layer that bonds to bare metal of metal seal surfaces 54, 58 and a conventional abradable material layer thereover. As used herein, “coating” indicates a multi-layered material, and “layer” indicates individual levels of the coating.

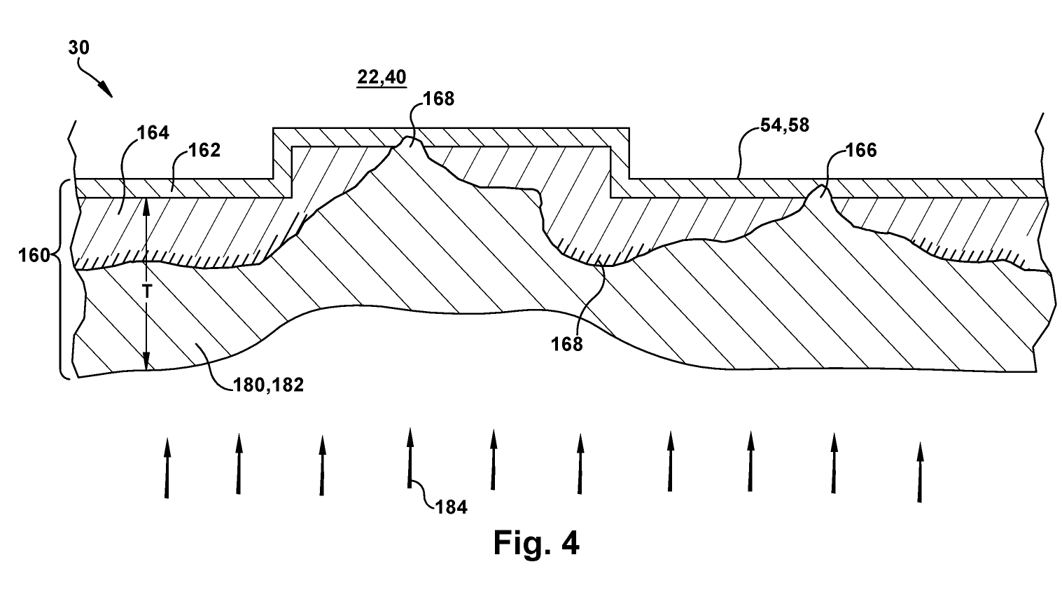

FIG. 4 shows an enlarged, cross-sectional view of metal seal surfaces 54, 58 in accordance with embodiments of the disclosure. As illustrated, ST stationary component 30 may include metal seal surface(s) 54, 58 including an abradable material coating 160 thereon in accordance with embodiments of the disclosure. Abradable material coating 160 may include a bond layer 162 on metal seal surface 54, 58. Bond layer 162 may include any now known or later developed bonding material(s) typically used to bond an abradable material to a bare metal surface. Bond layer 162 may include but is not limited to: nickel chromium aluminum yttrium alloy powder. Although shown as a single layer, bond layer 162 may include one or more layers of bonding material.

Abradable material coating 160 also includes a used abradable material layer 164 over bond layer 162. That is, abradable material layer 164 has been used in steam turbine 10 and has been exposed to all of the various environmental conditions therein, e.g., high temperature, moisture, and, most notably, abrasion through interacting friction with abradable seal elements (teeth) 52, 56, as previously described relative to abradable material coating 60 (FIG. 3). Consequently, used abradable material layer 164 may include wear areas 166 therein that may extend through bond layer 162 to metal seal surface 54, 58. In any event, used abradable material layer 160 has a non-uniform thickness caused by the wear, not by the steps. That is, even in an area of metal seal surfaces 54, 58 devoid of a step, layer 164 would have a non-uniform thickness caused by the wear. Used abradable material layer 64 may also include oxidation 168 or foreign object damage (FOD) thereon and/or therein. As understood in the art, oxidation 168 my color abradable material layer 164 to a dark red shade. As will be described in greater detail herein, FIG. 4 also shows abradable material coating 160 including a new abradable material layer 180 over used abradable material layer 164.

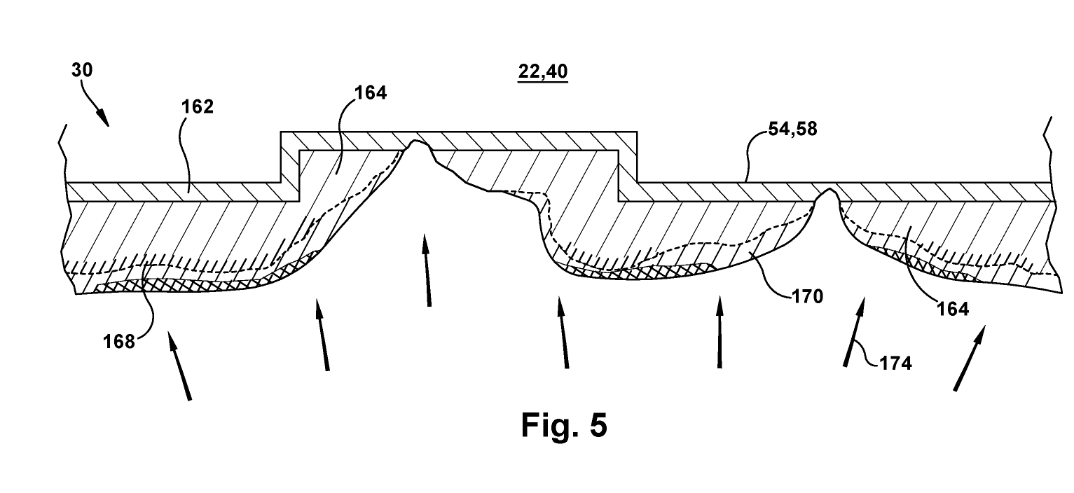

Referring to FIG. 5, used abradable material layer 164 is shown in a state as removed from steam turbine 10, i.e., prior to formation of new abradable material layer 180 (FIG. 4). In accordance with a method according to embodiments of the disclosure, as shown in FIG. 5, a portion 170 of used abradable material layer 164 on metal seal surface 54, 58 of vanes 22 or casing 40 (e.g., a first or stationary component) that interacts with abradable seal element 52 or 56 (e.g., a second or rotating/moving component) may be removed. Portion 170 may be removed, for example, by particle blasting 174 using, e.g., aluminum oxide or other appropriate particles. The removing process may leave a substantial portion of metal seal surface 54, 58 covered by used abradable material layer 164, e.g., greater than 60%. That is, the removing includes cleaning only portion 170 of the used abradable material layer 164, not all of it. In any event, in contrast to conventional approaches, used abradable material layer 164 is not fully removed.

Returning to FIG. 4, abradable material coating 160 may also include a new abradable material layer 180 on used abradable material layer 164. New abradable material layer 180 is applied after the removal process shown in FIG. 5. New abradable material layer 180 creates non-oxidized abradable material layer 182 over used, oxidized abradable material layer 164. Further, new (non-oxidized) abradable material layer 180 creates a substantially uniform thickness abradable material coating 160 with oxidized abradable material layer 164. In one embodiment, a combined thickness T of used abradable material layer 164 and new abradable material layer 180 is thicker than an initial thickness of used abradable material layer 164 prior to use thereof. In this fashion, although abradable seal elements 52, 56 have been worn, they need not be replaced because the thicker abradable material coating 160 is thicker and closes any gap therebetween. In one embodiment, combined thickness T may be approximately 2.0 millimeters (mm) to 4.5 mm, and the initial thickness may be, as noted previously, no greater than approximately 1 mm. In another embodiment, combined thickness T may be approximately 3.1 millimeters (mm) to 4.4 mm. In one particular embodiment, combined thickness T may be approximately 4.5 millimeters (mm). In another embodiment, combined thickness T may be approximately 3.0 millimeters, and in another embodiment, combined thickness T may be approximately 2.0 millimeters.

New abradable material layer 180 may be formed by thermal spraying abradable material onto used abradable material layer 164. It has been discovered that abradable material will adhere to used abradable material layer 164 when applied in this manner despite the lack of bonding material. In one embodiment, the thermal spraying may include any now known or later developed thermal spray system including, for example, a thermal spray gun, flow meters, feed mechanisms and, where applicable, an inline air filter. Where steam turbine 10 is sufficiently large, the removing process and thermal spraying process may occur with ST stationary component 30 and steam turbine rotor 12 in situ within steam turbine 10. As noted, a combined thickness T of used abradable material layer 164 and new abradable material layer 180 is thicker than an initial thickness of used abradable material layer 164 prior to use thereof. Consequently, when ST stationary component 30 according to embodiments of the disclosure is in steam turbine 10, new abradable material layer 180 at least decreases a gap G (FIG. 2) between coating 160 and abradable seal element 52, 56 in the operative state. In some instances, coating 160 may completely close gap G (FIG. 2). Abradable material layers 164, 180 may include any now known or later developed abradable material such as but not limited to a nickel-chromium-iron-aluminum hexagonal boron nitride powder (e.g., model GT56 available from Oerlikon Metco).

Abradable material coating 160 allows for restoring performance by adding thicker abradable material layers without removing and completely refurbishing a used abradable material coating, and/or replacing costly steam turbine components. The process also does not require dis-assembly or reassembly of blades or shipping of parts to other locations and thus lowers the risk of damaging the rotor from blade removal and assembly. Adding abradable material to the metal sealing surfaces also reduces the gap that steam can leak through, ideally bringing the sealing surfaces back to nominal dimensions, serving to minimize performance loss from an “as new” condition.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method, comprising:
removing only a portion of a used abradable material layer on a metal sealing surface of a first component that interacts with an abradable sealing element extending from a second component, the first and second component sealingly moving relative to one another in an operative state; and
thermal spray coating a new abradable material layer on the used abradable material layer, after the removing.

2. The method of claim 1, wherein the removing leaves a substantial portion of the metal sealing surface covered by the used abradable material layer.

3. The method of claim 1, wherein the removing includes particle blasting the used abradable material layer with aluminum oxide particles.

4. The method of claim 1, wherein the removing includes cleaning only the portion of the used abradable material layer.

5. The method of claim 1, wherein a combined thickness of the used abradable material layer and the new abradable material layer is thicker than an initial thickness of the used abradable material layer prior to use thereof.

6. The method of claim 5, wherein the combined thickness is approximately 3.1 millimeters (mm) to 4.4 mm, and the initial thickness is no greater than approximately 1 mm.

7. The method of claim 1, wherein the thermal spray coating the new abradable material layer at least decreases a gap between the metal sealing surface and the abradable sealing element in the operative state of the first and second components.

8. The method of claim 1, wherein the used abradable material layer includes oxidation.

9. The method of claim 1, wherein the first component includes a steam turbine stationary component and the second component includes a steam turbine rotor, and wherein the removing and thermal spraying occur with the steam turbine stationary component and the steam turbine rotor in situ within a steam turbine.

10. A steam turbine (ST) stationary component, comprising:
a metal sealing surface including an abradable material coating thereon, the abradable material coating including:
a bond layer on the metal sealing surface, and
an oxidized abradable material layer over the bond layer, the oxidized abradable layer having a non-uniform thickness; and
a non-oxidized abradable material layer over the oxidized abradable material layer, the non-oxidized abradable material layer creating a substantially uniform thickness abradable material coating with the oxidized abradable material layer.

11. The ST stationary component of claim 10, wherein a combined thickness of the oxidized abradable material layer and the non-oxidized abradable material layer is thicker than an initial thickness of the oxidized abradable material layer prior to use thereof.

12. The ST stationary component of claim 11, wherein the combined thickness is between approximately 2.0 millimeters (mm) to 4.5 mm, and the initial thickness is no greater than approximately 1 mm.

13. The ST stationary component of claim 10, wherein a combined thickness of the oxidized abradable material layer and the non-oxidized abradable material layer is between approximately 2.0 millimeters (mm) to 4.5 mm.

14. The ST stationary component of claim 13, wherein the combined thickness is approximately 4.5 millimeters (mm).

15. The ST stationary component of claim 13, wherein the combined thickness is approximately 3.0 millimeters.

16. The ST stationary component of claim 13, wherein the combined thickness is approximately 2.0 millimeters.
